(19) United States
(12) Patent Application Publication
(10) Pub. No.: US 2017/0169726 A1
(43) Pub. Date: Jun. 15, 2017

(54) METHOD AND APPARATUS FOR MANAGING FEEDBACK BASED ON USER MONITORING

(71) Applicants: AT&T INTELLECTUAL PROPERTY I, LP, Atlanta, GA (US); AT&T MOBILITY II LLC, Atlanta, GA (US)

(72) Inventors: Quinn Aguirre, Duluth, GA (US); FULVIO ARTURO CENCIARELLI, Suwanee, GA (US); JOHN POTTS DAVIS, III, Marietta, GA (US); JEFFREY MIKAN, ATLANTA, GA (US)

(21) Appl. No.: 14/963,287

(22) Filed: Dec. 9, 2015

(51) Int. Cl. G09B 19/04; G09B 5/02

(52) U.S. Cl. CPC G09B 19/04; G09B 5/02

(57) ABSTRACT

Aspects of the subject disclosure may include, for example, obtaining identification information associated with a group of users participating in a communication session in which content is presented, determining weighting factors associated with the group of users according to the identification information, obtaining sensor data captured from a sensor device in proximity to the group of users, determining individual feedback data associated with each of the group of users based on the sensor data, determining aggregate feedback data for the group of users based on the individual feedback data where the determining of the aggregate feedback data comprises applying the weighting factors to the individual feedback data, and providing feedback information indicative of the aggregate feedback data. Other embodiments are disclosed.

### FIELD OF THE DISCLOSURE

The subject disclosure relates to a method and apparatus for managing feedback based on user monitoring.

### BACKGROUND

Users have various options to select from in communication services. As users have access to more devices for these services, the users are becoming more distracted from their real life engagements. In addition, users are often unable to see body language since more of their communications are done virtually. This can lead to poor communication between users. Speakers in conferences are talking to more people that are virtually present. When the audience is listening, speakers can miss queues that the people are confused. In addition, outside events may be pulling key individuals attention away from the presentation.

### BRIEF DESCRIPTION OF THE DRAWINGS

Reference will now be made to the accompanying drawings, which are not necessarily drawn to scale, and wherein:

FIGS. 1 and 2 depict illustrative embodiments of systems that can provide media services, monitor audience reaction and perform actions according to the audience reaction;

FIG. 3 depicts an illustrative embodiment of a method used in portions of the systems described in FIGS. 1 and 2;

FIG. 4 depicts an illustrative embodiment of a communication system that provides media services including monitoring audience reaction and performing actions according to the audience reaction;

FIG. 5 depicts an illustrative embodiment of a communication device; and

FIG. 6 is a diagrammatic representation of a machine in the form of a computer system within which a set of instructions, when executed, may cause the machine to perform any one or more of the methods described herein.

### DETAILED DESCRIPTION

The subject disclosure describes, among other things, illustrative embodiments for providing user feedback by monitoring audience members. Weighting factors can be applied to some or all of the members of an audience and an aggregate audience feedback can be determined that is based on identifying particular feedback from particular users in the audience members. Various members of the audience can receive the feedback information (or other information associated with audience feedback), including a presenter of content, a first audience member associated with a second audience member (e.g., the individual feedback of the second audience member can be provided to the first audience member), and so forth.

The determination of the individual and/or aggregate feedback can be utilized for providing additional information, including notifying a presenter of particular audience members that are not understanding the content, and/or providing additional content with a more detailed explanation of the content to those particular audience members without providing the additional content to other audience members that have been determined to understand the content.

One or more aspects of the subject disclosure are a method including obtaining, by a system including a processor, identification information for a group of users participating in a communication session, where the group of users includes first and second users. The method includes determining, by the system, a first weighting factor associated with the first user according to the identification information. The method includes determining, by the system, a second weighting factor associated with the second user according to the identification information. The method includes obtaining, by the system, sensor data captured from a sensor device in proximity to the first and second users. The method includes determining, by the system, first feedback data associated with the first user based on the sensor data. The method includes determining, by the system, second feedback data associated with the second user based on the sensor data. The method includes determining, by the system, aggregate feedback data for the group of users based on the first and second feedback data, where the determining of the aggregate feedback data comprises applying the first weighting factor to the first feedback data and applying the second weighting factor to the second feedback data. The method includes providing, by the system, feedback information indicative of the aggregate feedback data to a communication device of a third user of the group of users, where the feedback information is presentable by the communication device of the third user.

One or more aspects of the subject disclosure include a machine-readable storage medium, comprising executable instructions that, when executed by a media processor, facilitate performance of operations, including presenting content at a display during a communication session, where a first user is in proximity to the display, and where the first user is a member of a group of users participating in the communication session. The processor can obtain first sensor data captured from a first sensor device in proximity to the first user during the presenting of the content. The processor can provide the first sensor data to a network server to enable the network server to determine aggregate feedback data for the group of users based on applying weighting factors to first feedback data associated with the first user and to second feedback data associated with a second user of the group of users, where the first feedback data is determined based on the first sensor data, and where the second feedback data is determined based on second sensor data captured from a second sensor device in proximity to the second user that is being presented the content. The processor can receive adjusted content from the network server, where the adjusted content is generated according to the aggregate feedback data. The processor can present the adjusted content at the display during the communication session.

One or more aspects of the subject disclosure include a network server having a processor and a memory that stores executable instructions that, when executed by the processor, facilitate performance of operations, including obtaining identification information associated with a group of users participating in a communication session in which content is presented. The processor can determine weighting factors associated with the group of users according to the identification information. The processor can obtain sensor data captured from a sensor device in proximity to the group of users. The processor can determine individual feedback data associated with each of the group of users based on the sensor data. The processor can determine aggregate feedback data for the group of users based on the individual feedback data, where the determining of the aggregate feedback data comprises applying the weighting factors to the individual feedback data. The processor can provide feedback information indicative of the aggregate feedback data to a communication device of a presenter presenting the content, where the feedback information is presentable by the communication device of the presenter.

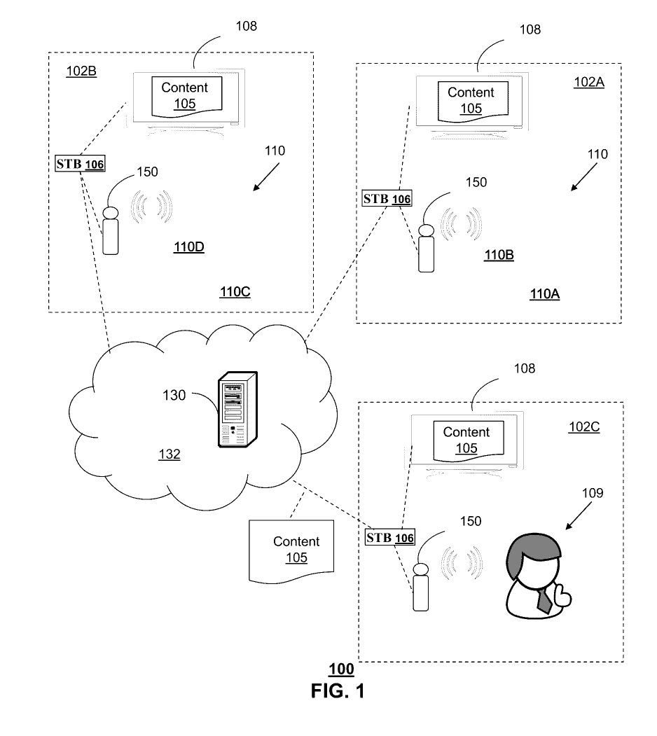

FIG. 1 depicts an illustrative embodiment of a system 100 in which a communication session can be established via network 132 for communication devices associated with a group of users which enables monitoring audience feedback associated with some or all of the group of users. Network 132 can be various types of networks (e.g., wired and/or wireless networks) and can operate according to various communication protocols.

In one embodiment, the communication session can be utilized for presenting content 105 by one or more media processors 106 (e.g., a set top box) at a display 108 (e.g., a television). An audience or group of users 110 can be viewing or otherwise consuming the content 105. In this example, six users are illustrated for audience 110 which are located at different locations 102A and 102B, although the audience could be a single user or any other number of users, and can be located at a same location or any number of different locations (including mobile locations). This example illustrates set top boxes 106 participating in the communication session, however, any type of communication device can participate in the communication session, including mobile phones, desktop computers, vehicle communication systems, and so forth. The content 105 can be various types of content, including video, still images, audio, voice, data, text and/or messaging.

In one embodiment, the content 105 can be sourced by another communication device (illustrated as set top box 106 at location 102C) of another user 109. As an example, the communication session can be an online meeting that enables desktop sharing among participants in the communication session (e.g., user 109 can share a document on his or her processor 106 with the processors 106 of the group of users 110). As another example, the communication session can be a video conference that enables video captured at location 102C to be presented to participants in the communication session (e.g., images and/or audio of user 109 can be transmitted via network 132 for presentation by processors 106 of the group of users 110). In one embodiment, participation by a particular member of the group 110 in the communication session can be known by other members of the communication session. In another embodiment, participation by a particular member of the group 110 in the communication session may not be known by other members of the communication session. In one embodiment, the communication session can be multiple communication sessions which may be a same type of session (e.g., video conferences) or different types of sessions (e.g., a video conference and an audio-only conference).

In another embodiment, the content 105 can be sourced by another device, which may be an end user device or a content provider device. As an example, the communication session can be an online meeting that enables a document stored remotely (e.g., at a content source server) to be presented to participants in the communication session (e.g., user 109 can manipulate or otherwise control presentation the document via his or her processor 106). As another example, the content 105 can be sourced by various devices which may be end user devices and/or content provider devices. For instance, the communication session can be a video conference that enables video captured at locations 102A, 102B and/or 102C to be presented to participants in the communication session, including in a telepresence conference environment simulating the users 110 being all present at a same location such as described in U.S. Pat. No. 8,947,497, the disclosure of which is hereby incorporated by reference in its entirety.

System 100 enables a device(s) (e.g., network server 130) to determine audience feedback associated with the presentation of the content 105. In one embodiment, the audience feedback can be obtained automatically without any of the users 110 directly providing feedback (e.g., during the communication session the audience feedback is captured automatically without prompting the users for any feedback). In one embodiment, the audience feedback can be determined individually for some or all of the users 110 and then aggregated based on the particular users that were utilized to capture the feedback, such as by applying weighting factors to feedback data associated with different users of the group of users 110. Information, such as an identity of a user, can be utilized for determining or otherwise selecting the particular weighting factor.

In one embodiment, one or more sensor devices 150 (only one of which is shown at each location 102A, 102B, 102C) can capture sensor data of a sensed audience reaction for the group of users 110. The sensor data can be of various types including images, audio, and/or motion information. In one embodiment, the sensor device 150 can be integrated with the media processor 106 or can be otherwise in communication with the media processor to provide the sensor data to the media processor. In another embodiment, the sensor device 150 can be a separate device from the media processor 106, where the sensor device provides the sensor data to the network server 130 with or without sharing the sensor data with the media processor.

In one embodiment, combinations of sensor devices 150 can be utilized, such as a first sensor device that is an audio recorder of the media processor 106 and a second sensor device that is a camera for capturing images of the users 110. In another embodiment, the sensor device 150 can be part of an end user device of one or more of the users in the group of users 110. For example, a mobile phone of a user of the group of users 110 can record audio and provide that audio to the media processor 106 and/or to the network server 130. In addition to audio and image recordings, the sensor device 150 can capture other sensor data, such as motion detection, lighting and so forth. Captured sensor data may or may not be shared with the media processor(s) 106, such as a sensor device 150 directly transmitting the sensor data to the network server 130 without providing the sensor data to the media processor 106.

In one or more embodiments, the same captured sensor data can be utilized for determining feedback for multiple users of the group of users 110. For example, an image can be captured at location 102A where the image includes both the user 110A and the user 110B. Facial recognition can be applied to the user to determine facial expressions for both users 110A and 110B and those facial expressions can be analyzed for determining user reactions.

The aggregation of individual feedback by applying weighting factors associated with different users of the group of users 110 enables a more focused evaluation of the audience reaction to the presentation of the content 105. For example, content 105 can be a presentation regarding a proposal to change an ingredient utilized for making a product where the replacement ingredient can provide a six percent cost savings in the product manufacture and a twenty percent reduction in time in the product manufacture. A first user 110A may be the CEO of the manufacturing company. The second user 110B may be a director of marketing for the company. The third user 110C may be a director of operations for the company. The fourth user 110D may be the director of procurement for the company. In this example, identification information can be obtained by the network server 130 for the group of users 110 and weighting factors can be applied by the network server 130 to individual feedback captured for the users according to the identification information. For instance, sensor devices 150 can capture images, audio and/or motion for the group of users 110 and provide that sensor data to the network server 130 for analysis. Other sensor data can also be captured and provided to the network server 130, such as detecting activity information for particular users (e.g., text messaging or a voice call during the presentation of the content 105). Any monitoring of user reactions, including determining device activity of a particular user, can be performed with the authorization of that particular user. The sensor data can be utilized to determine individual feedback for some or all of the users 110 (e.g., individual feedback for users 110A, 110B, 110C, 110D), including feedback data indicative of interest, a lack of interest, comprehension, lack of comprehension, and so forth. Aggregate feedback data for the group of users 101 can be determined based on applying the individual weighting factors to the individual feedback data. For instance, the feedback data of the first user 110A may be weighted the heaviest due to the first user's position as CEO and ultimate decision maker. The feedback data of the second user 110B may be weighted less since the changing of the ingredient may have little impact on marketing. The feedback data of the third user 110C may be more heavily weighted since the changing of the ingredient will alter production time. The feedback data of the fourth user 110D may be weighted the least since the changing of the ingredient will require procuring a different ingredient which requires more work for the fourth user and thus the fourth user's feedback is expected to be more negative.

In one embodiment, the aggregated feedback can be presented by the network server 130. For example, feedback information indicative of the aggregate feedback data can be transmitted from the network server 130 to the media processor 106 of user 109 at location 102C that was presenting the content 105. The feedback information can then be presented to user 109 by that media processor 106. The feedback information can be presented in various forms, including text and/or graphically to enable the user 109 to know the level of interest or understanding of the users 110 and/or any other determined feedback. In one embodiment, the feedback information can indicate a level of interest within a range of interest. In another embodiment, the level of interest can be mapped to various segments of the content 105.

In one embodiment, system 100 enables mapping individual and/or aggregate feedback to a particular segment of the content 105 being presented. For example, the network server 130 can determine a content context of a first segment of the content 105 being presented. The content context determination can be performed based on various factors and utilizing various techniques, such as segments of the content including or otherwise being associated with metadata that can be accessed where the metadata describes the particular content context of the particular segment. In another embodiment, pattern recognition can be applied (e.g., by the network server 130) to the segment of the content to determine the content context (e.g., determining keywords being spoken and/or determining key objects being shown). In one embodiment, a segment of content can be identified that was presented at a time in proximity to captured sensor data. The content context of that segment of content can be determined, such as via metadata or pattern recognition. Additional content can then be obtained based on the content context and can be provided to one or more of the users 110 (e.g., according to a determination based on individual feedback and/or aggregate feedback indicating a lack of comprehension).

In one embodiment, the network server 130 can determine individual feedback data by comparing captured reactions with expected reactions for the particular user. For example, user profiles and/or historical reactions for that particular user can be analyzed (e.g., in conjunction with the content context) to determine the expected user reaction for that particular user. As an example, a first user 110A that has shown in the past (according to a history of audio reactions) that he or she seldom asks any questions during content associated with financial information, can be expected to not ask questions during presentation of similar content even if he or she is very interested in the content 105. However, the first user 110A that has shown in the past (according to a history of monitored user device activity) that he or she does not answer text messages during a presentation, can be expected to not be engaged in messaging during the communication session. Other expected reactions can be determined for some or all of the group of users 101 according to a history of reactions during previous communication sessions which can be correlated with information indicating an interest (e.g., the particular user authorizing an expenditure with respect to a particular project being presented during a previous communication session) or a lack of interest (e.g., the particular user denying an expenditure with respect to a particular project being presented during a previous communication session).

In one embodiment, sensor data can be obtained for all users (e.g., the group of users 110 and user 109) that are participating in the communication session. In another embodiment, sensor data can be obtained for all users 110 that are participating in the communication session except the user 109 presenting the content 105. In another embodiment, sensor data can be obtained for only some of the group of users 110, such as identifying key audience members according to the identification information and further aggregating the individual feedback of only the determined key audience members according to the weighting factors of each of those key audience members. In one embodiment, captured sensor data can be analyzed and/or filtered so that a determination of audience feedback is made based only on sensor data for particular key members (e.g., identifying and filtering out recorded audio of non-key audience members while identifying and recognizing recorded audio of key audience members).

In one embodiment, network server 130 can provide additional feedback information to one or more users of the group of users 110, where the additional feedback information is indicative of individual feedback data associated with one or more other users of the group of users 110. For example, first user 110A located at location 102A may be the director of research for a company and third user 110C located at location 102B may be an engineer in the research division. Network server 130 can obtain individual feedback data for first user 110A indicating that the first user is highly interested in the content 105 and can provide additional feedback information to media processor 106 at location 102B for presenting a notification that the first user is highly interested in the content 105. In another embodiment, additional feedback information indicating that the first user 110A is highly interested in the content 105 can be provided to another communication device of the third user 110C, such as a text message to a mobile phone of the third user indicating the high level of interest of the first user in the content (where the mobile phone is not participating in the communication session in which the content 105 is presented). In another embodiment, the notification of the level of interest (or other determined individual feedback data for the first user 110A) provided to the media processor 106 at location 102B or provided to the other communication device of the third user 110C can be mapped to a segment of the content 105, such as indicating a high level of interest in a first project described earlier in the content but indicating a low level of interest in a second project described later in the content.

In one embodiment, the individual feedback data can be indicative of a lack of comprehension and/or a lack of interest of a user 110B, and the network server 130 can identify a segment of content being presented at a time in proximity to the sensor data being captured from the sensor device 150 at location 102A; determine a content context of the segment of content; obtain additional content based on the content context (e.g., additional content that provides a more detailed explanation or additional content that is more persuasive); and provide the additional content to the media processor 106 at location 102A without providing the additional content to the media processor 106 at location 102B. The additional content can be presented in various formats, such as text, audio, and/or graphically. In one embodiment, the additional content can be an overlay presented over the content (e.g., presented near an edge of the display 108) so that the content 105 and the additional content can be simultaneously viewed by a subset of the users 110 that are all located at location 102A.

In one embodiment, network server 130 can provide a notification that the additional content has been provided to the media processor 106 at location 102C so that user 109 is made aware that the additional content has been provided to the particular user that is determined not to understand the segment of the content 105. In one embodiment, the notification of the additional content is provided without providing the additional content to the media processor 106 at location 102C. In one embodiment, the sensor data comprises video of the first user 110A, and network server 130 applies image recognition to the video to determine a first action associated with the first user, where the determining of the individual feedback data associated with the first user is based on the first action. In one embodiment, the determined first action is associated with operating an end user device, writing notes, speaking with another user, or a combination thereof. In one embodiment, the obtaining of the sensor data by the network server 130 includes receiving the sensor data captured from the sensor device housed in a media processor participating in the communication session.

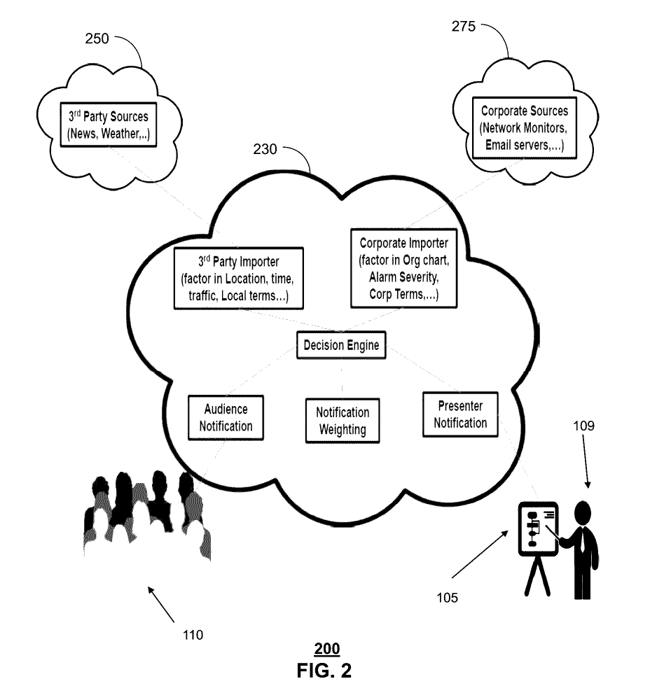

FIG. 2 depicts an illustrative embodiment of system 200 that enables actions to be taken during a communication session according to monitored audience reactions to segments of content. The actions can include generating and providing notifications of a state of mind of one, some or all of the audience members or group of users 110 (which are depicted together but can be in different locations), such as to the device of a presenter 109. The state of mind(s) can be determined based on the monitored audience feedback with or without correlation to the particular segment of content being presented at the time of capturing the feedback. In one embodiment, by comparing an expected audience reaction according to an actual audience reaction and further comparing that differential to a context of a particular segment of content being presented, system 200 can detect a level of interest or a change in the level of interest. In one embodiment, the actions can include providing additional content to one, some or all of the audience members 110 where a lack of understanding is detected and where the additional content is a detailed explanation of the particular segment of content.

In one embodiment, one or more servers such as cloud 230 can obtain identification information associated with the group of users 110 participating in a communication session in which content 105 is presented. The cloud 230 can determine weighting factors associated with the group of users 110 according to the identification information. Other information can also be used for determining the weighting factors, including user profile information associated with the group of users 110, user preference information (e.g., provided by the user 109 who is presenting the content 105), a determined subject matter of the content, and/or an amount of interaction by a particular user during the communication session (e.g., a first user that asks a large number of questions during the communication session may be given a heavier weighting than a second user that asks no questions).

The cloud 230 can obtain sensor data captured from sensor device(s) (e.g., device 150 in FIG. 1) in proximity to the group of users 110, such as a camera, an audio recorder, and/or a motion detector. The cloud 230 can determine individual feedback data associated with some or all of the group of users 110 based on the sensor data. The cloud 230 can determine aggregate feedback data for the group of users 110 based on the individual feedback data, where the determining of the aggregate feedback data includes applying the weighting factors to the individual feedback data. The cloud 230 can provide feedback information indicative of the aggregate feedback data. For example, the feedback information can be provided to a communication device of the user 109 who is presenting the content 105. The feedback information can be presented to the user 109 by a communication device of the user 109, such as by a media processor 106 in an overlay over the content 105 so that the user 109 can see the content being presented in addition to the aggregated audience reaction. The cloud 230 can provide other feedback information, such as providing a notification to user 109 that is indicative of individual feedback data for a key member(s) of the audience.

In one embodiment, system 200 can provide real-time feedback to the presenter 109 that includes feedback mapped to segments of the presented content 105. In one embodiment, news, emergency alerts, or other data (e.g., from third party sources 250) can be monitored for events that may distract the audience, such as natural or local disaster or weather alerts. In one embodiment, email volume and/or an email originator (e.g., via requesting information from an enterprise server 275 where the users are employees of the company) can be monitored to determine a level of attention to the presented content 105. In one embodiment, the presenter 109 can be alerted that one, some or all of the users 110 are confused and that the presenter needs to explain particular segments of the content 105, such as acronyms or basic concepts.

In one embodiment, facial expressions can be determined by cloud 230 via imaging and pattern recognition to ascertain user feedback, such as a detected eyebrow squint indicating a need to explain more or a detected eye roll indicating a need to move on to the next segment of the content 105. Other user actions can be detected and the corresponding feedback provided to the presenter, such as a user taking pictures of the presentation indicating a need to wait before changing the current slide, users rapidly taking notes indicating a need to slow down the explanation, and/or users falling asleep indicating a need to take a break. In one embodiment, cloud 230 can communicate with a health tracking device(s) (e.g., heart rate monitor) to determine an emotion of a user(s) (e.g., liked topic or disliked topic).

In one embodiment, the cloud 230 can determine that a term is known by all but a few of the users 110. For those few, the term can be pushed to their active device (e.g., their end user device engaged in the communication session) so that the presenter does not have to explain the particular term to everyone. In one embodiment, the feedback information can be presented via actual facial expressions, such as showing a captured image of a face of a user where the user's eyes are starting to close indicating a lack of interest.

In one embodiment, cloud 230 can use the sensors 150 (shown in FIG. 1) to recognize the presence of individuals that are outside the conference “approved” list. This information can be utilized to update a meeting invite, auto-shut down conference line, and/or provide a security warning to an administrator. In another embodiment, cloud 230 can detect a mute button going on and off and determine from this action that there is a distraction (e.g., a cube conversation) or that one of the users is trying to get a word in edgewise during the communication session.

Cloud 230 can provide feedback to the presenter 109 on the audience engagement in the current communication session. In one embodiment, the presenter 109 (or someone else such as a meeting host) can designate key individuals among the users 110. In one embodiment, only the key individuals are monitored. In another embodiment, the key individuals would be tracked with a tighter “attention span” than the remaining individuals. In one embodiment, if too high of a percentage of the key individuals are becoming distracted, then the presenter 109 would get notified in order to either increase their attention or reschedule the meeting.

In one embodiment, different sensor data can be captured for different members of the group of users 110. For example, cloud 230 can capture a first type of sensor data (e.g., images, audio, motion, texting, voice calls) for key members (either designated or determined from identification information) and can capture a second type of sensor data (e.g., only audio) for key members. In another embodiment, the sensor data can be filtered, such as removing background noise, to isolate the sensed audience reaction.

In one embodiment, speech recognition can be applied to the sensor data to identify words spoken by the users 110. Based on the speech recognition, an individual feedback can be determined according to the words. For example, a speaker can be identified and words indicative of questioning the effectiveness of a proposal can be identified.

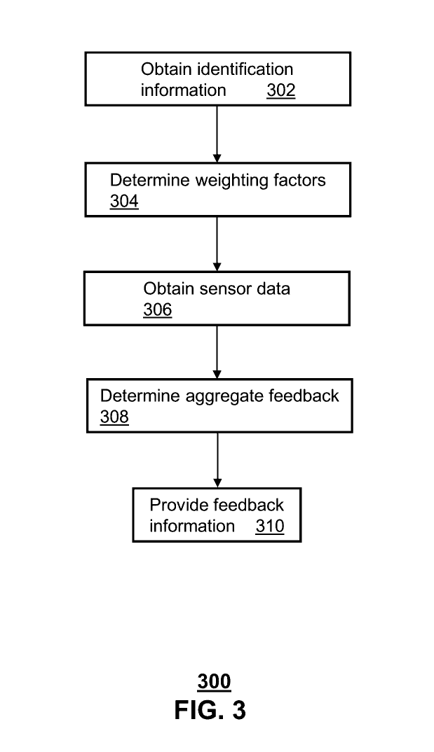

FIG. 3 depicts an illustrative embodiment of a method 300 used by systems 100 and 200 for performing actions according to monitoring user feedback. Method 300 can be performed by various devices and combinations of devices including network devices and/or end user devices. Method 300 can commence at 302 where identification information is obtained that is associated with a group of users participating in a communication session in which content is presented. The identification information can be obtained from various sources, including identification information included with the establishment of the communication session, calendar invites, device identities, user input, user profiles, and so forth.

At 304, weighting factors associated with the group of users can be determined according to the identification information. As an example, it can be determined that the audience includes three directors of different departments and six engineers that are supervised by those directors. In this example, the directors' feedback may be given more weight than the engineers. In another example, the feedback of a particular director(s) and/or a particular engineer(s) may be given more weight due to that particular director(s) and/or a particular engineer(s) being more closely involved with the content being presented during the communication session. The identification information can include a name of a user, a title of a user, responsibilities of a user and/or other information that is correlated to the user and enables distinguishing one user from another.

At 306, sensor data can be obtained which is captured by a sensor device(s) in proximity to the group of users. The sensor data can be in various forms, including video, images, audio, motion, engaging in other communication session, device activity unrelated to the communication session, and so forth. The sensor data can include any captured or determined information for a user that can be analyzed to determine feedback for that user (e.g., level of comprehension, and/or level of interest).

At 308, individual feedback data can be determined which is associated with each of the group of users based on the sensor data. For example, facial recognition can be applied to facial images of a user to detect an expression of dis-interest and the feedback data determined for that user can be a lack of interest. As another example, device activity can be detected for a user that is performing a web-based search for a term used during the presentation of the content to determine confusion and the feedback data determined for that user can be a lack of comprehension. Aggregate feedback data for the group of users can then be determined according to the individual feedback data. For example, aggregate feedback data can be determined by applying the weighting factors to the individual feedback data.

At 310, feedback information can be provided. In one embodiment, the feedback information can be indicative of the aggregate feedback data and can be provided to a communication device of a presenter presenting the content for presentation at the presenter's device. For instance, the aggregate feedback data may indicate that overall there is an interest in the content, where the individual feedback data for two key individuals is indicative of a very strong interest and the individual feedback data for two non-key individuals is indicative of a low interest. In this example, the communication device of the presenter can present a notice of the interest, which may or may not be mapped to a particular segment of the content. In one embodiment where notifications of aggregate feedback data are mapped to segments of the content, the notifications can be different for different segments.

The feedback information is not limited to an overall rating of the interest in the content or segment. For example, the aggregate feedback data may indicate that there is confusion regarding a segment of the content. In one embodiment, this notification can be presented to the presenter so that he or she can provide further details explaining the particular segment. In another embodiment, additional content can be provided (e.g., to be overlayed with the content being presented) to individual users whose individual feedback data indicated that there is confusion regarding a segment of the content. This additional content can be provided in conjunction with a notice to the presenter that the additional content has been provided.

While for purposes of simplicity of explanation, the respective processes are shown and described as a series of blocks in FIG. 3, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

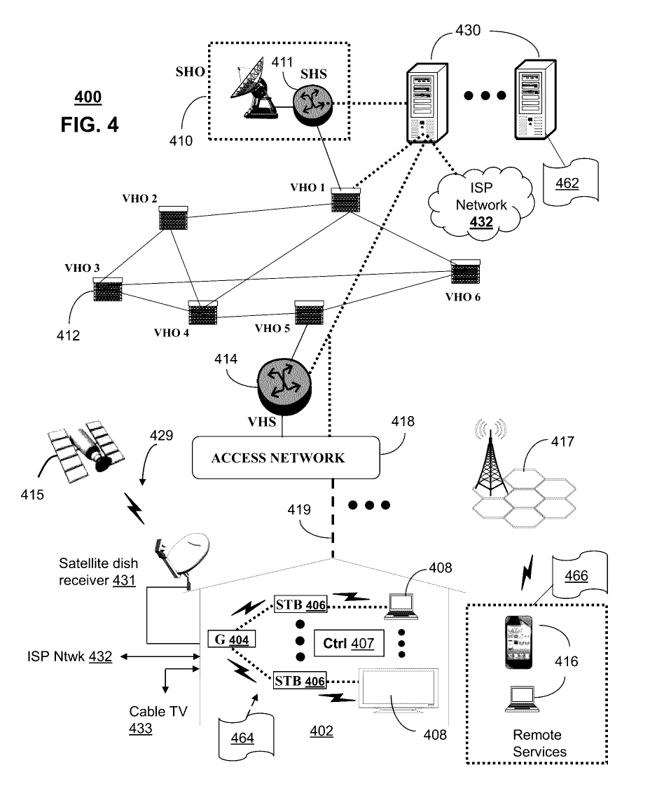

FIG. 4 depicts an illustrative embodiment of a first communication system 400 for delivering media content. The communication system 400 can represent an interactive television network, such as an Internet Protocol Television (IPTV) media system. Communication system 400 can be overlaid or operably coupled with systems 100 and 200 of FIGS. 1 and 2 as another representative embodiment of communication system 400. For instance, one or more devices illustrated in the communication system 400 of FIG. 4 can monitor audience feedback so that actions can be performed based on the reaction of the audience. For example, system 400 enables monitoring recipients of content to obtain feedback to determine interest, comprehension and other consumption characteristics. Feedback can be obtained from multiple individuals (e.g., at a same location or different locations) that are receiving content (such a video conference, online meeting, or audio conference call). The feedback can be obtained utilizing various devices, such as a media processor presenting the content, other devices (e.g., a camera in the room), and/or other end user device (e.g., a mobile phone being utilized for text messages during the video conference). The feedback can be weighted based on the identification of the individual and/or the particular context of the content at the time the feedback is received, such as weighting more heavily the feedback associated with engineers during a technical aspect of a video conference and then weighting more heavily the feedback of marketing persons during a sales portion of the video conference. System 400 also enables providing information determined from the feedback to other participants of the video conference. For example, an engineer can be provided a notification that the chief technology officer was very interested to a particular portion of the video conference.

The IPTV media system can include a super head-end office (SHO) 410 with at least one super headend office server (SHS) 411 which receives media content from satellite and/or terrestrial communication systems. In the present context, media content can represent, for example, audio content, moving image content such as 2D or 3D videos, video games, virtual reality content, still image content, and combinations thereof. The SHS server 411 can forward packets associated with the media content to one or more video head-end servers (VHS) 414 via a network of video head-end offices (VHO) 412 according to a multicast communication protocol.

The VHS 414 can distribute multimedia broadcast content via an access network 418 to commercial and/or residential buildings 402 housing a gateway 404 (such as a residential or commercial gateway). The access network 418 can represent a group of digital subscriber line access multiplexers (DSLAMs) located in a central office or a service area interface that provide broadband services over fiber optical links or copper twisted pairs 419 to buildings 402. The gateway 404 can use communication technology to distribute broadcast signals to media processors 406 such as Set-Top Boxes (STBs) which in turn present broadcast channels to media devices 408 such as computers or television sets managed in some instances by a media controller 407 (such as an infrared or RF remote controller).

The gateway 404, the media processors 406, and media devices 408 can utilize tethered communication technologies (such as coaxial, powerline or phone line wiring) or can operate over a wireless access protocol such as Wireless Fidelity (WiFi), Bluetooth®, Zigbee®, or other present or next generation local or personal area wireless network technologies. By way of these interfaces, unicast communications can also be invoked between the media processors 406 and subsystems of the IPTV media system for services such as video-on-demand (VoD), browsing an electronic programming guide (EPG), or other infrastructure services.

A satellite broadcast television system 429 can be used in the media system of FIG. 4. The satellite broadcast television system can be overlaid, operably coupled with, or replace the IPTV system as another representative embodiment of communication system 400. In this embodiment, signals transmitted by a satellite 415 that include media content can be received by a satellite dish receiver 431 coupled to the building 402. Modulated signals received by the satellite dish receiver 431 can be transferred to the media processors 406 for demodulating, decoding, encoding, and/or distributing broadcast channels to the media devices 408. The media processors 406 can be equipped with a broadband port to an Internet Service Provider (ISP) network 432 to enable interactive services such as VoD and EPG as described above.

In yet another embodiment, an analog or digital cable broadcast distribution system such as cable TV system 433 can be overlaid, operably coupled with, or replace the IPTV system and/or the satellite TV system as another representative embodiment of communication system 400. In this embodiment, the cable TV system 433 can also provide Internet, telephony, and interactive media services. System 400 enables various types of interactive television and/or services including IPTV, cable and/or satellite.

The subject disclosure can apply to other present or next generation over-the-air and/or landline media content services system.

Some of the network elements of the IPTV media system can be coupled to one or more computing devices 430, a portion of which can operate as a web server for providing web portal services over the ISP network 432 to wireline media devices 408 or wireless communication devices 416.

Communication system 400 can also provide for all or a portion of the computing devices 430 to function as an audience feedback monitor server (herein referred to as server 430). The server 430 can use computing and communication technology to perform function 462, which can include among other things, obtaining identification information for a group of users participating in a communication session where the group of users includes first and second users; determining a first weighting factor associated with the first user according to the identification information; determining a second weighting factor associated with the second user according to the identification information; obtaining sensor data captured from a sensor device in proximity to the first and second users; determining first feedback data associated with the first user based on the sensor data; determining second feedback data associated with the second user based on the sensor data; determining aggregate feedback data for the group of users based on the first and second feedback data where the determining of the aggregate feedback data comprises applying the first and second weighting factors to the first and second feedback data; and providing feedback information indicative of the aggregate feedback data to a communication device of a third user of the group of users, where the feedback information is presentable by the communication device of the third user.

For instance, function 462 of server 430 can be similar to the functions described with respect to network server 130 of system 100 and cloud 230 of system 200. The media processors 406 and wireless communication devices 416 can be provisioned with software functions 464 and 466, respectively, to utilize the services of server 430. For instance, functions 464 and 466 of media processors 406 and wireless communication devices 416 can be similar to the functions described for the devices 106 of FIG. 1 in accordance with method 300.

Multiple forms of media services can be offered to media devices over landline technologies such as those described above. Additionally, media services can be offered to media devices by way of a wireless access base station 417 operating according to common wireless access protocols such as Global System for Mobile or GSM, Code Division Multiple Access or CDMA, Time Division Multiple Access or TDMA, Universal Mobile Telecommunications or UMTS, World interoperability for Microwave or WiMAX, Software Defined Radio or SDR, Long Term Evolution or LTE, and so on. Other present and next generation wide area wireless access network technologies can be used in one or more embodiments of the subject disclosure.

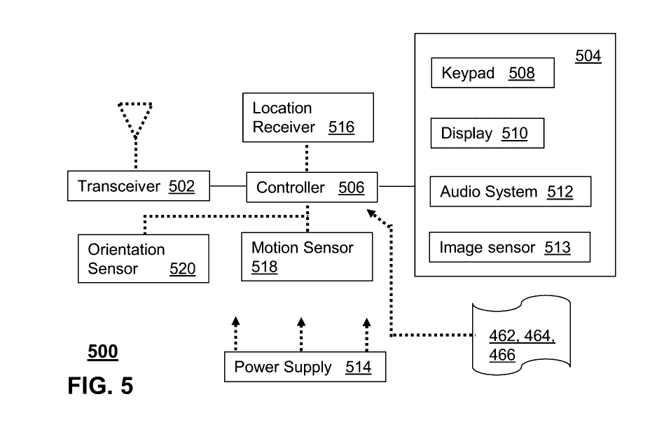

FIG. 5 depicts an illustrative embodiment of a communication device 500. Communication device 500 can serve in whole or in part as an illustrative embodiment of the devices depicted in systems 100, 200 and 400 and can be configured to perform portions of method 300. As an example, communication device 500 can present content at a display during a communication session where a first user is in proximity to the display and where the first user is a member of a group of users participating in the communication session; obtain first sensor data captured from a first sensor device in proximity to the first user during the presenting of the content; provide the first sensor data to a network server to enable the network server to determine aggregate feedback data for the group of users based on applying weighting factors to first feedback data associated with the first user and to second feedback data associated with a second user of the group of users, where the first feedback data is determined based on the first sensor data, and where the second feedback data is determined based on second sensor data captured from a second sensor device in proximity to the second user that is being presented the content; receive adjusted content from the network server where the adjusted content is generated according to the aggregate feedback data; and present the adjusted content at the display during the communication session.

In one embodiment, communication device 500 can provide, to a network server, identification information associated with the first user, where the providing of the identification information enables the network server to determine a first weighting factor of the weighting factors to be applied to the first feedback data. In another embodiment, communication device 500 can provide an activity request to an end user device of the first user, where the end user device is not participating in the communication session; receive activity information indicative of another communication session in which the end user device is participating; and provide the activity information to the network server, where the first feedback data associated with the first user is determined based on the activity information.

Communication device 500 can comprise a wireline and/or wireless transceiver 502 (herein transceiver 502), a user interface (UI) 504, a power supply 514, a location receiver 516, a motion sensor 518, an orientation sensor 520, and a controller 506 for managing operations thereof. The transceiver 502 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 502 can also be adapted to support circuit-switched wireline access technologies (such as PSTN), packet-switched wireline access technologies (such as TCP/IP, VoIP, etc.), and combinations thereof.

The UI 504 can include a depressible or touch-sensitive keypad 508 with a navigation mechanism such as a roller ball, a joystick, a mouse, or a navigation disk for manipulating operations of the communication device 500. The keypad 508 can be an integral part of a housing assembly of the communication device 500 or an independent device operably coupled thereto by a tethered wireline interface (such as a USB cable) or a wireless interface supporting for example Bluetooth®. The keypad 508 can represent a numeric keypad commonly used by phones, and/or a QWERTY keypad with alphanumeric keys. The UI 504 can further include a display 510 such as monochrome or color LCD (Liquid Crystal Display), OLED (Organic Light Emitting Diode) or other suitable display technology for conveying images to an end user of the communication device 500. In an embodiment where the display 510 is touch-sensitive, a portion or all of the keypad 508 can be presented by way of the display 510 with navigation features.

The display 510 can use touch screen technology to also serve as a user interface for detecting user input. As a touch screen display, the communication device 500 can be adapted to present a user interface with graphical user interface (GUI) elements that can be selected by a user with a touch of a finger. The touch screen display 510 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 510 can be an integral part of the housing assembly of the communication device 500 or an independent device communicatively coupled thereto by a tethered wireline interface (such as a cable) or a wireless interface.

The UI 504 can also include an audio system 512 that utilizes audio technology for conveying low volume audio (such as audio heard in proximity of a human ear) and high volume audio (such as speakerphone for hands free operation). The audio system 512 can further include a microphone for receiving audible signals of an end user. The audio system 512 can also be used for voice recognition applications. The UI 504 can further include an image sensor 513 such as a charged coupled device (CCD) camera for capturing still or moving images.

The power supply 514 can utilize common power management technologies such as replaceable and rechargeable batteries, supply regulation technologies, and/or charging system technologies for supplying energy to the components of the communication device 500 to facilitate long-range or short-range portable applications. Alternatively, or in combination, the charging system can utilize external power sources such as DC power supplied over a physical interface such as a USB port or other suitable tethering technologies.

The location receiver 516 can utilize location technology such as a global positioning system (GPS) receiver capable of assisted GPS for identifying a location of the communication device 500 based on signals generated by a constellation of GPS satellites, which can be used for facilitating location services such as navigation. The motion sensor 518 can utilize motion sensing technology such as an accelerometer, a gyroscope, or other suitable motion sensing technology to detect motion of the communication device 500 in three-dimensional space. The orientation sensor 520 can utilize orientation sensing technology such as a magnetometer to detect the orientation of the communication device 500 (north, south, west, and east, as well as combined orientations in degrees, minutes, or other suitable orientation metrics).

The communication device 500 can use the transceiver 502 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 506 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 500.

Other components not shown in FIG. 5 can be used in one or more embodiments of the subject disclosure. For instance, the communication device 500 can include a reset button (not shown). The reset button can be used to reset the controller 506 of the communication device 500. In yet another embodiment, the communication device 500 can also include a factory default setting button positioned, for example, below a small hole in a housing assembly of the communication device 500 to force the communication device 500 to re-establish factory settings. In this embodiment, a user can use a protruding object such as a pen or paper clip tip to reach into the hole and depress the default setting button. The communication device 500 can also include a slot for adding or removing an identity module such as a Subscriber Identity Module (SIM) card. SIM cards can be used for identifying subscriber services, executing programs, storing subscriber data, and so forth.

The communication device 500 as described herein can operate with more or less of the circuit components shown in FIG. 5. These variant embodiments can be used in one or more embodiments of the subject disclosure.

The communication device 500 can be adapted to perform the functions of devices 106, 108, 130, 150, 220, 250, 275 of FIGS. 1 and 2, the media processor 406, the media devices 408, or the portable communication devices 416 of FIG. 4. It will be appreciated that the communication device 500 can also represent other devices that can operate in systems 100 and 200 of FIGS. 1 and 2, and communication system 400 of FIG. 4, such as a gaming console and a media player. In addition, the controller 506 can be adapted in various embodiments to perform the functions 462-466.

Upon reviewing the aforementioned embodiments, it would be evident to an artisan with ordinary skill in the art that said embodiments can be modified, reduced, or enhanced without departing from the scope of the claims described below. For example, the presentation and audience monitoring can be performed at a single location. In one embodiment, a mobile device(s) can participate in the communication session and can be utilized for capturing sensory data, such as capturing an image of the user as the user is watching the presentation.

In one embodiment, the aggregating of the feedback data can be performed locally without utilizing a network server, such as where a first media processor of a presenter receives the identification information, determines the weighting factors, receives the individual feedback data, applies the weighting factors to aggregate the feedback data, and present feedback information indicative of the aggregate feedback data.

In one embodiment, the delivery of feedback notifications (e.g., indicating an overall lack of interest or indicating an individual's lack of interest) and/or the delivery of additional content can be according to user preferences, such as designated by the presenter of the content and/or designated by the user that will be receiving the notification or the additional content. In one embodiment, the additional content that can be provided to a particular user(s) can also include a link for further additional content. In one embodiment, a presenter can be provided with a notification if a user accesses the further additional content via the link.

In one embodiment, the notification of the aggregate and/or individual feedback data can be presented graphically so that as the feedback changes the graphical representation changes. For instance, a graph of interest (or comprehension) over time can be presented as an overlay on a communication device of the presenter showing changes in interest or comprehension.

Other actions can be triggered by the determination of a level of interest or a change in the level of interest, such as proposing different content to the audience or to a subset of the audience. Other embodiments can be used in the subject disclosure.

It should be understood that devices described in the exemplary embodiments can be in communication with each other via various wireless and/or wired methodologies. The methodologies can be links that are described as coupled, connected and so forth, which can include unidirectional and/or bidirectional communication over wireless paths and/or wired paths that utilize one or more of various protocols or methodologies, where the coupling and/or connection can be direct (e.g., no intervening processing device) and/or indirect (e.g., an intermediary processing device such as a router).

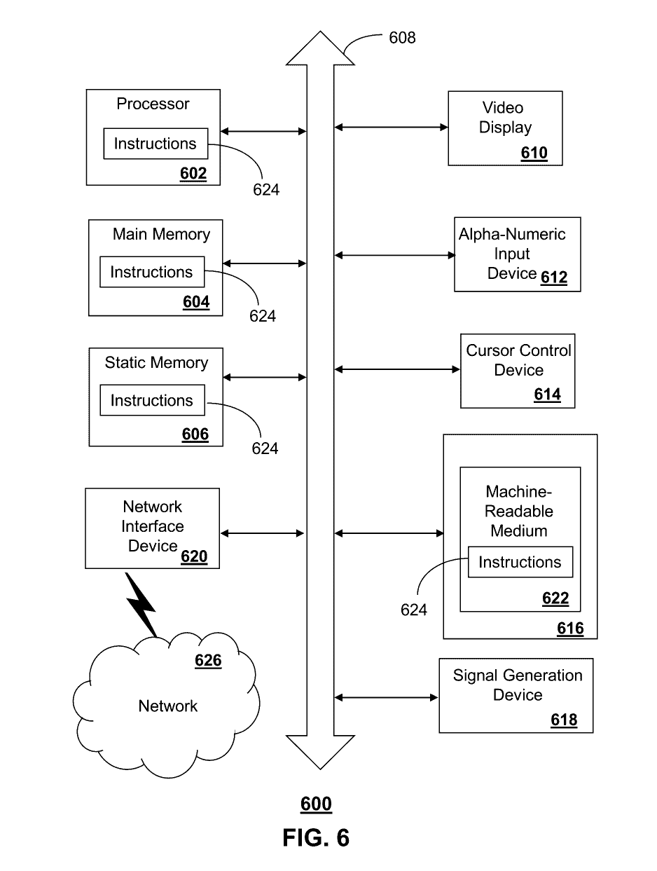

FIG. 6 depicts an exemplary diagrammatic representation of a machine in the form of a computer system 600 within which a set of instructions, when executed, may cause the machine to perform any one or more of the methods described above. One or more instances of the machine can operate, for example, as the media processor 106, the network server 130, the cloud 230, the server 430, the media processor 406 and other devices of FIGS. 1-2 and 4 in order to monitor user feedback and perform actions according to that feedback. In some embodiments, the machine may be connected (e.g., using a network 626) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

The computer system 600 may include a processor (or controller) 602 (e.g., a central processing unit (CPU)), a graphics processing unit (GPU, or both), a main memory 604 and a static memory 606, which communicate with each other via a bus 608. The computer system 600 may further include a display unit 610 (e.g., a liquid crystal display (LCD), a flat panel, or a solid state display). The computer system 600 may include an input device 612 (e.g., a keyboard), a cursor control device 614 (e.g., a mouse), a disk drive unit 616, a signal generation device 618 (e.g., a speaker or remote control) and a network interface device 620. In distributed environments, the embodiments described in the subject disclosure can be adapted to utilize multiple display units 610 controlled by two or more computer systems 600. In this configuration, presentations described by the subject disclosure may in part be shown in a first of the display units 610, while the remaining portion is presented in a second of the display units 610.

The disk drive unit 616 may include a tangible computer-readable storage medium 622 on which is stored one or more sets of instructions (e.g., software 624) embodying any one or more of the methods or functions described herein, including those methods illustrated above. The instructions 624 may also reside, completely or at least partially, within the main memory 604, the static memory 606, and/or within the processor 602 during execution thereof by the computer system 600. The main memory 604 and the processor 602 also may constitute tangible computer-readable storage media.

Dedicated hardware implementations including, but not limited to, application specific integrated circuits, programmable logic arrays and other hardware devices can likewise be constructed to implement the methods described herein. Application specific integrated circuits and programmable logic array can use downloadable instructions for executing state machines and/or circuit configurations to implement embodiments of the subject disclosure. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the subject disclosure, the operations or methods described herein are intended for operation as software programs or instructions running on or executed by a computer processor or other computing device, and which may include other forms of instructions manifested as a state machine implemented with logic components in an application specific integrated circuit or field programmable gate array. Furthermore, software implementations (e.g., software programs, instructions, etc.) including, but not limited to, distributed processing or component/object distributed processing, parallel processing, or virtual machine processing can also be constructed to implement the methods described herein. It is further noted that a computing device such as a processor, a controller, a state machine or other suitable device for executing instructions to perform operations or methods may perform such operations directly or indirectly by way of one or more intermediate devices directed by the computing device.

While the tangible computer-readable storage medium 622 is shown in an example embodiment to be a single medium, the term “tangible computer-readable storage medium” should be taken to include a single medium or multiple media (e.g., a centralized or distributed database, and/or associated caches and servers) that store the one or more sets of instructions. The term “tangible computer-readable storage medium” shall also be taken to include any non-transitory medium that is capable of storing or encoding a set of instructions for execution by the machine and that cause the machine to perform any one or more of the methods of the subject disclosure. The term “non-transitory” as in a non-transitory computer-readable storage includes without limitation memories, drives, devices and anything tangible but not a signal per se.

The term “tangible computer-readable storage medium” shall accordingly be taken to include, but not be limited to: solid-state memories such as a memory card or other package that houses one or more read-only (non-volatile) memories, random access memories, or other re-writable (volatile) memories, a magneto-optical or optical medium such as a disk or tape, or other tangible media which can be used to store information. Accordingly, the disclosure is considered to include any one or more of a tangible computer-readable storage medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are from time-to-time superseded by faster or more efficient equivalents having essentially the same functions. Wireless standards for device detection (e.g., RFID), short-range communications (e.g., Bluetooth®, WiFi, Zigbee®), and long-range communications (e.g., WiMAX, GSM, CDMA, LTE) can be used by computer system 600.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. The exemplary embodiments can include combinations of features and/or steps from multiple embodiments. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

Less than all of the steps or functions described with respect to the exemplary processes or methods can also be performed in one or more of the exemplary embodiments. Further, the use of numerical terms to describe a device, component, step or function, such as first, second, third, and so forth, is not intended to describe an order or function unless expressly stated so. The use of the terms first, second, third and so forth, is generally to distinguish between devices, components, steps or functions unless expressly stated otherwise. Additionally, one or more devices or components described with respect to the exemplary embodiments can facilitate one or more functions, where the facilitating (e.g., facilitating access or facilitating establishing a connection) can include less than every step needed to perform the function or can include all of the steps needed to perform the function.

In one or more embodiments, a processor (which can include a controller or circuit) has been described that performs various functions. It should be understood that the processor can be multiple processors, which can include distributed processors or parallel processors in a single machine or multiple machines. The processor can be used in supporting a virtual processing environment. The virtual processing environment may support one or more virtual machines representing computers, servers, or other computing devices. In such virtual machines, components such as microprocessors and storage devices may be virtualized or logically represented. The processor can include a state machine, application specific integrated circuit, and/or programmable gate array including a Field PGA. In one or more embodiments, when a processor executes instructions to perform “operations”, this can include the processor performing the operations directly and/or facilitating, directing, or cooperating with another device or component to perform the operations.

The Abstract of the Disclosure is provided with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method, comprising:
obtaining, by a system including a processor, identification information for a group of users participating in a communication session, wherein the group of users includes first and second users;
determining, by the system, a first weighting factor associated with the first user according to the identification information;
determining, by the system, a second weighting factor associated with the second user according to the identification information;
obtaining, by the system, sensor data captured from a sensor device in proximity to the first and second users;
determining, by the system, first feedback data associated with the first user based on the sensor data;
determining, by the system, second feedback data associated with the second user based on the sensor data;
determining, by the system, aggregate feedback data for the group of users based on the first and second feedback data, wherein the determining of the aggregate feedback data comprises applying the first weighting factor to the first feedback data and applying the second weighting factor to the second feedback data; and
providing, by the system, feedback information indicative of the aggregate feedback data to a communication device of a third user of the group of users, the feedback information being presentable by the communication device of the third user.

2. The method of claim 1, wherein the communication device of the third user is participating in the communication session, wherein the communication session comprises a video conference, wherein the third user is a presenter of content during the communication session, wherein the group of users includes fourth users, and wherein the weighting factors, the sensor data and feedback data are obtained for all members of the group of users except the third user.

3. The method of claim 2, wherein the sensor device comprises a first sensor device and a second sensor device, wherein the first sensor device is in proximity to the first user, wherein the second sensor device is in proximity to the second user, and wherein the first user is at a first location that is remote from a second location of the second user.

4. The method of claim 1, wherein the third user is a presenter of content during the communication session, and further comprising providing, by the system, additional feedback information to another communication device of the second user of the group of users, the additional feedback information being indicative of the first feedback data associated with the first user, the additional feedback information being presentable by the other communication device of the second user.

5. The method of claim 1, wherein the first feedback data is indicative of a lack of comprehension of the first user, and further comprising:
identifying, by the system, a segment of content being presented at a display of a first end user device of the first user at a time in proximity to the sensor data being captured from the sensor device;
determining, by the system, a content context of the segment of content;
obtaining, by the system, additional content based on the content context; and
providing, by the system, the additional content to the first end user device of the first user without providing the additional content to a second end user device of the second user.

6. The method of claim 5, wherein the communication device of the third user is participating in the communication session, wherein the third user is a presenter of content during the communication session, and further comprising providing, by the system, a notification of the additional content to the communication device of the third user.

7. The method of claim 6, wherein the notification of the additional content is provided to the communication device of the third user without providing the additional content to the communication device of the third user.

8. The method of claim 1, wherein the sensor data comprises an image captured of the first and second users, and further comprising applying, by the system, image recognition to the image to detect a first facial expression of the first user and a second facial expression of the second user.

9. The method of claim 1, wherein the sensor data comprises video of the first user, and further comprising:
applying, by the system, image recognition to the video to determine a first action associated with the first user,
wherein the determining of the first feedback data associated with the first user is based on the first action.

10. The method of claim 9, wherein the first action is associated with operating an end user device, writing notes, or a combination thereof.

11. The method of claim 1, wherein the obtaining of the sensor data by the system comprises receiving the sensor data captured from the sensor device housed in a media processor participating in the communication session.

12. A machine-readable storage medium, comprising executable instructions that, when executed by a processor, facilitate performance of operations, comprising:
presenting content at a display during a communication session, wherein a first user is in proximity to the display, wherein the first user is a member of a group of users participating in the communication session;
obtaining first sensor data captured from a first sensor device in proximity to the first user during the presenting of the content;
providing the first sensor data to a network server to enable the network server to determine aggregate feedback data for the group of users based on applying weighting factors to first feedback data associated with the first user and to second feedback data associated with a second user of the group of users, wherein the first feedback data is determined based on the first sensor data, and wherein the second feedback data is determined based on second sensor data captured from a second sensor device in proximity to the second user that is being presented the content;
receiving adjusted content from the network server, wherein the adjusted content is generated according to the aggregate feedback data; and
presenting the adjusted content at the display during the communication session.

13. The machine-readable storage medium of claim 12, wherein the adjusted content comprises additional content associated with the content, wherein the providing of the first sensor data to the network server enables the network server to provide feedback information indicative of the aggregate feedback data to a communication device of a third user of the group of users, the feedback information being presentable by the communication device of the third user, and wherein the communication device of the third user is a source of the content.

14. The machine-readable storage medium of claim 12, wherein the operations further comprise providing, to the network server, identification information associated with the first user, wherein the providing of the identification information enables the network server to determine a first weighting factor of the weighting factors to be applied to the first feedback data.

15. The machine-readable storage medium of claim 12, wherein the operations further comprise:
providing an activity request to an end user device of the first user, wherein the end user device is not participating in the communication session;
receiving activity information indicative of another communication session in which the end user device is participating; and
providing the activity information to the network server,
wherein the first feedback data associated with the first user is determined based on the activity information.

16. A network server, comprising:
a processor; and
a memory that stores executable instructions that, when executed by the processor, facilitate performance of operations, comprising:
obtaining identification information associated with a group of users participating in a communication session in which content is presented;
determining weighting factors associated with the group of users according to the identification information;
obtaining sensor data captured from a sensor device in proximity to the group of users;
determining individual feedback data associated with each of the group of users based on the sensor data;
determining aggregate feedback data for the group of users based on the individual feedback data, wherein the determining of the aggregate feedback data comprises applying the weighting factors to the individual feedback data; and
providing feedback information indicative of the aggregate feedback data to a communication device of a presenter presenting the content, the feedback information being presentable by the communication device of the presenter.

17. The network server of claim 16, wherein the sensor data comprises video and wherein the operations further comprise:
applying image recognition to the video to determine a first action associated with a first user of the group of users, wherein the determining of the individual feedback data associated with the first user is based on the first action, and wherein the first action is associated with operating an end user device, writing notes, or a combination thereof.

18. The network server of claim 16, wherein the individual feedback data associated with a first user of the group of users is indicative of a lack of comprehension of the first user, and wherein the operations further comprise:
identifying a segment of the content being presented at a display of a first end user device of the first user at a time in proximity to the sensor data being captured from the sensor device;
determining a content context of the segment of the content;
obtaining additional content based on the content context; and
providing the additional content to the first end user device of the first user without providing the additional content to a second end user device of a second user of the group of users.

19. The network server of claim 18, wherein the operations further comprise providing a notification of the additional content to the communication device of the presenter, wherein the notification of the additional content is provided to the communication device of the presenter without providing the additional content to the communication device of the presenter.

20. The network server of claim 16, wherein the sensor data comprises an image captured of first and second users of the group of users, and wherein the operations further comprise applying image recognition to the image to detect a first facial expression of the first user and a second facial expression of the second user.
